(19) United States
(12) Patent Application Publication
(10) Pub. No.: US 2023/0319618 A1
(43) Pub. Date: Oct. 5, 2023

(54) AERIAL USER EQUIPMENT AND METHOD FOR TRANSMISSION OF MEASUREMENT REPORT

(71) Applicant: Lenovo (Beijing) Limited, Beijing (CN)

(72) Inventors: Jing Han, Chaoyang District (CN); Haiming Wang, Xicheng District (CN); Min Xu, Haidian District (CN); Jie Hu, Changping District (CN)

(73) Assignee: Lenovo (Beijing) Limited, Beijing (CN)

(21) Appl. No.: 18/021,123

(22) PCT Filed: Sep. 11, 2020
(86) PCT No.: PCT/CN2020/114753

§ 371 Date: Feb. 13, 2023

(51) Int. Cl. H04W 24/10; H04B 7/185; H04B 17/318

(52) U.S. Cl. CPC H04W 24/10; H04B 7/18504; H04B 17/328

(57) ABSTRACT

The present application relates to an aerial user equipment in a UAV swarm and a method for transmission of measurement report. The method includes: receiving a configuration of measurement from a base station; determining whether to transmit a measurement report to the base station or to another aerial user equipment according to the configuration; and transmitting the measurement report to the base station or to the another aerial user equipment according to a result of determining whether to transmit the measurement report to the base station or to the another aerial user equipment.

### TECHNICAL FIELD

The present disclosure generally relates to a user equipment and a method for transmission of measurement report, and relates more particularly to an aerial user equipment in an UAV swarm and a method for transmission of measurement report.

### BACKGROUND OF THE INVENTION

In conventional network, technique of measurement report is developed. Briefly, the user equipment can measure the strength of signals that the user equipment receives from the base station, and then report the measurement to the base station for the base station to adjust the operations of the network.

However, existed procedures of transmission of measurement report are not suitable for aerial user equipment. Specific details of transmission of measurement report for aerial user equipment in a UAV swarm have not been discussed yet and there are still some issues that need to be solved.

### BRIEF SUMMARY OF THE INVENTION

One embodiment of the present disclosure provides a method of an aerial user equipment (UE). The method includes: receiving a configuration of measurement from a base station (BS); determining whether to transmit a measurement report to the BS or to another aerial UE according to the configuration; and transmitting the measurement report to the BS or to the another aerial UE according to a result of determining whether to transmit the measurement report to the BS or to the another aerial UE.

Another embodiment of the present disclosure provides an apparatus. According to an embodiment of the present disclosure, the apparatus includes: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions are configured to, with the at least one processor, cause the apparatus to perform a method according to an embodiment of the present disclosure.

### BRIEF DESCRIPTION OF THE DRAWINGS

In order to describe the manner in which advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a wireless communication system according to an embodiment of the present disclosure.

FIG. 2 illustrates a UAV swarm and a BS according to an embodiment of the present disclosure.

FIG. 3 illustrates message transmission between a UAV swarm and a BS according to an embodiment of the present disclosure.

FIG. 4 illustrates message transmission between a UAV swarm and a BS according to an embodiment of the present disclosure.

FIG. 5 illustrates a flow chart of a method for wireless communications according to an embodiment of the present disclosure.

FIGS. 6A to 6C illustrate flow charts of a method for wireless communications according to an embodiment of the present disclosure.

FIG. 7 illustrates an example block diagram of an apparatus according to an embodiment of the present disclosure.

### DETAILED DESCRIPTION OF THE INVENTION

The detailed description of the appended drawings is intended as a description of preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

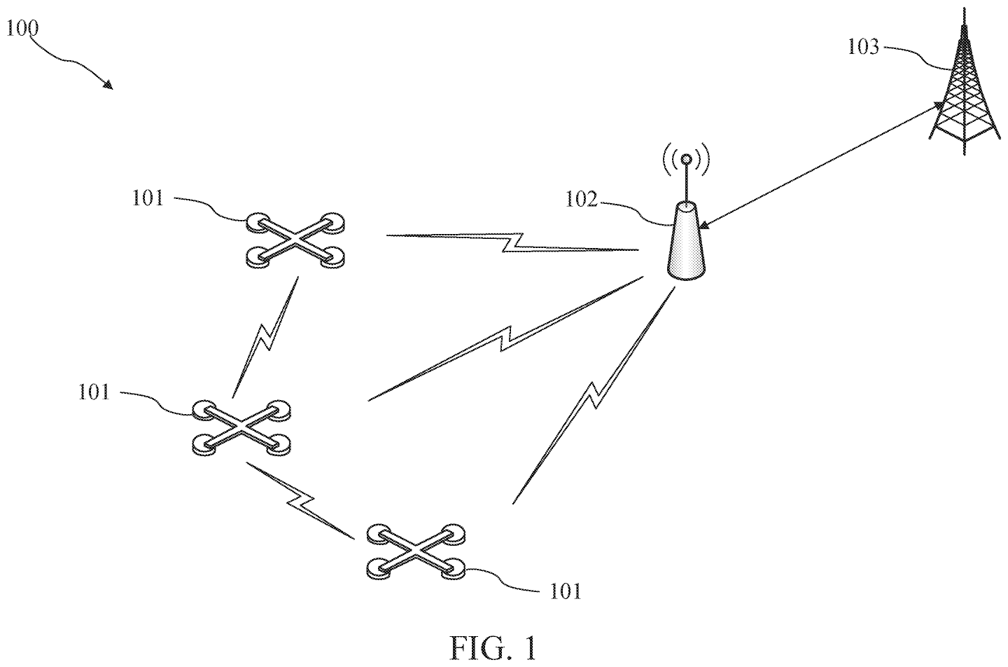

Referring to FIG. 1, a wireless communication system 100 may include aerial user equipment (UE) 101, a base station (BS) 102 and a core network (CN) 103. Although a specific number of the aerial UEs 101, the BS 102 and the CN 103 are depicted in FIG. 1, it is contemplated that any number of the aerial UEs 101, the BSs 102 and the CNs 103 may be included in the wireless communication system 100.

The CN 103 may include a core Access and Mobility management Function (AMF) entity. The BS 102, which may communicate with the CN 103, may operate or work under the control of the AMF entity. The CN 103 may further include a User Plane Function (UPF) entity, which communicatively coupled with the AMF entity.

The BS 102 may be distributed over a geographic region. In certain embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding BS(s).

The aerial UEs 101 may include, for example, but is not limited to, computing devices that are capable of sending and receiving communication signals on a wireless network. Further, the computing devices are capable of flying or are disposed on flying machine. The aerial UEs 101 may include, for example, but is not limited to, unmanned aerial vehicle (UAV). The aerial UEs 101 may communicate directly with the BS 102 via Uu links. The aerial UEs 101 may communicate with each other via sidelink.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G Reduced capability NR of the 3GPP protocol, wherein the BSs 102 transmit data using an OFDM modulation scheme on the downlink (DL) and the aerial UEs 101 transmit data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the BS 102 may communicate using other communication protocols, such as the IEEE 802.11 family of wireless communication protocols. Further, in some embodiments of the present application, the BS 102 may communicate over licensed spectrums, whereas in other embodiments the BS 102 may communicate over unlicensed spectrums. The present application is not intended to be limited to the implementation of any particular wireless communication system architecture or protocol. In yet some embodiments of present application, the BS 102 may communicate with the aerial UEs 101 using the 3GPP 5G protocols.

According to some existed agreements, technique of measurement report may be introduced in the wireless communication system 100. However, specific details of transmission of measurement report for the aerial UEs 101 have not been discussed yet and there are still some issues that need to be solved.

In some embodiments, when all aerial UEs 101 perform transmission of measurement report to the BS 102 via Uu links directly, it may result in significant signaling overhead on Uu links, especially during the phases of taking off and landing on. Therefore, some aerial UEs 101 may perform transmission of measurement report to a specific aerial UE 101 via sidelink.

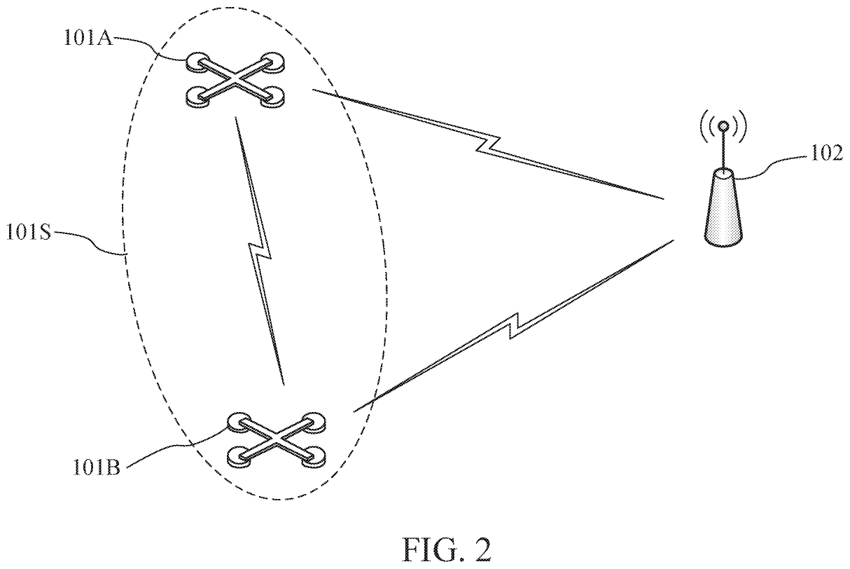

In particular, referring to FIG. 2, there may be an aerial UE swarm 101S including an aerial UE 101A and an aerial UE 101B. In the aerial UE swarm 101S, the aerial UE 101A may be a master aerial UE and the aerial UE 101B may be a member aerial UE. It should be noted that the master aerial UE and the member aerial UE may have the same abilities, and the master aerial UE may be selected (e.g., by the BS 102 or by the aerial UEs of the aerial UE swarm 101S) from the aerial UE swarm 101S for handling the transmissions of measurement reports in the aerial UE swarm 101S.

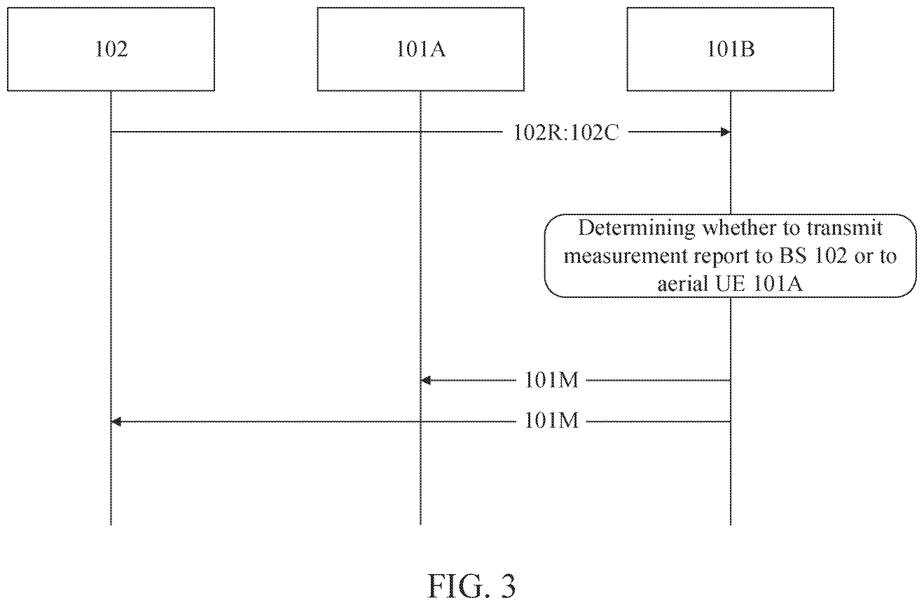

Please refer to FIG. 3 in conjunction with FIG. 2. The BS 102 may transmit a Radio Resource Control (RRC) message 102R to the aerial UE 101B. The RRC 102R may include a configuration 102C of measurement report. Then, when the aerial UE 101B needs to report measurement result, the aerial UE 101B may determine whether to transmit a measurement report 101M to the BS 102 or to the aerial UE 101A according to the configuration 102C. After determining which node to transmit the measurement report 101M to, the aerial 101B may transmit the 101M to the BS 102 or to the aerial UE 101A. In other words, the two transmissions of the measurement report 101M shown in FIG. 3 may be alternatively performed according to the determination.

In some embodiments, the aerial UE 101B may initial determination of transmitting the measurement report 101M when some conditions are satisfied. In detail, the configuration 102C may indicate to the aerial UE 101B a measurement report type. After receiving the RRC 102R including the configuration 102C, the aerial UE 101B may determine whether to transmit the measurement report 101M when the condition of corresponding measurement report type is fulfilled.

In some implementations, the measurement report type may be time-based, and the configuration 102C may include a time period. After receiving the RRC 102R including the configuration 102C, the aerial UE 101B may be indicated time-based measurement report and may periodically determine to transmit the measurement report 101M. In other words, the aerial UE 101B may determine to transmit the measurement report 101M every time period.

In some implementations, the measurement report type may be event-based, and the configuration 102C may indicate the aerial UE 101B at least one measurement event. After receiving the RRC 102R including the configuration 102C, the aerial UE 101B may be indicated the at least one measurement event and may determine to transmit the measurement report 101M when the at least one measurement report event is triggered.

It should be noted that the at least one measurement event may include measurement report trigger events: (1) A3/A4/A5; (2) A3/A4/A5 with multi-cell measurement trigger; or (3) H1/H2 defined in 3GPP specifications. More specifically, according to 3GPP specifications, A3 is event of “neighbour becomes offset better than serving”, A4 is event of “neighbour becomes better than threshold”, A5 is event of “serving becomes worse than threshold1 and neighbour becomes better than threshold2”, H1 is event of “the aerial UE height is above a threshold”, and H2 is event of “the channel busy ratio is below a threshold”.

In some embodiments, in addition to the initiation of the determination of transmitting the measurement report 101M, the aerial UE 101B may start to determine which node to transmit the measurement report 101M to. In detail, the configuration 102C may further include: (1) indicator of enabling/disabling a function of performing transmission of measurement report to another aerial UE; (2) a threshold ‘TH1’ of distance for performing transmission of measurement report to another aerial UE. The aerial UE 101B may start to determine which node to transmit the measurement report 101M to when one or more of the following conditions is/are fulfilled (i.e., when necessary information used for determining which node to transmit the measurement report 101M to is ready):
a) the aerial UE 101B identifies a special aerial UE (e.g., the master aerial UE 101A of the aerial UE swarm 101S), which may collect the measurement report 101M of the aerial UE 101B and forward the measurement report 101M to the BS 102, according to the configuration 102C;
b) the aerial UE 101B communicates with the special aerial UE (e.g., the master aerial UE 101A of the aerial UE swarm 101S) via a unicast connection (e.g., PC5-RRC connection);
c) the aerial UE 101B is enabled with the function of performing transmission of measurement report to the special aerial UE (e.g., the master aerial UE 101A of the aerial UE swarm 101S) according to the indicator of the configuration 102C;
d) the aerial UE 101B is configured with the at least one measurement event (e.g., measurement report trigger events A3/A4/A5 or H1/H2 defined in 3GPP specifications) according to the configuration 102C;
e) the at least one measurement event is triggered;
f) the aerial UE 101B is configured with the threshold ‘TH1’ of distance according to the configuration 102C.

It should be noted that, in condition a), the special aerial UE may be identified by an upper layer (such as the layer above AS layer), e.g., application layer of the aerial UE 101B. Further, the upper layer of the aerial UE 101B may indicate an identification of the special aerial UE to AS layer for the aerial UE 101B.

In some embodiments, after starting to determine which node to transmit the measurement report 101M to, distance condition may be introduced for the aerial UE 101B to determine whether to transmit the measurement 101M to the BS 102 or to the aerial UE 101A. Particularly, distance between the aerial UE 101B and the aerial UE 101A may be used to determine whether to transmit the measurement 101M to the BS 102 or to the aerial UE 101A.

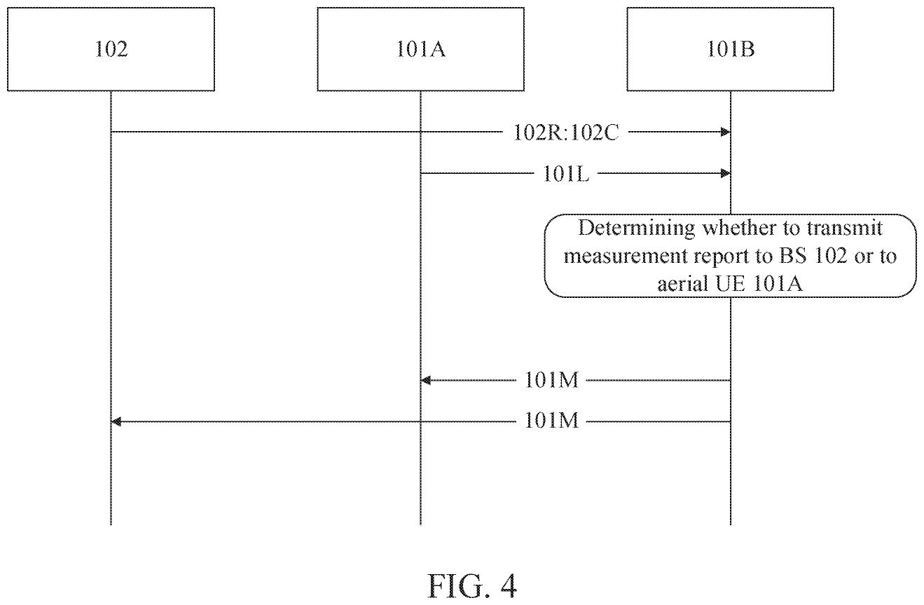

Please refer to FIG. 4 in conjunction with FIG. 2. In detail, the aerial UE 101B may receive location information 101L from the aerial UE 101A. The aerial UE 101B may calculate a distance between the aerial UE 101B and the aerial UE 101A according to the location information 101L of the aerial UE 101A. Then, the aerial UE 101B may determine whether the distance is less than the threshold ‘TH1’ of the configuration 102C. When the distance is determined less than the threshold ‘TH1’ of the configuration 102C, the aerial UE 101B may transmit the measurement report 101M to the aerial UE 101A or may abandon the measurement report 101M. When the distance is determined equal to or greater than the threshold ‘TH1’ of the configuration 102C, the aerial UE 101B may transmit the measurement report 101M to the BS 102.

It should be noted that the configuration 102C may further include a threshold ‘TH2’ of distance. The threshold ‘TH2’ is less than the threshold ‘TH1’. When the distance is determined less than the threshold ‘TH1’, the aerial UE 101B may further determine whether the distance is less than the threshold ‘TH2’. When the distance is determined equal to or greater than the threshold ‘TH2’, the aerial UE 101B may transmit the measurement report 101M to the aerial UE 101A. When the distance is determined less than the threshold ‘TH2’ (i.e., the aerial UE 101B may be very adjacent to the aerial UE101A), the aerial UE 101B may not transmit the measurement report 101M to the aerial UE 101A or to the BS 102.

More specifically, when the aerial UE 101B is very adjacent to the aerial UE101A, it means that the measurement report 101M of the aerial UE 101B may be similar to a measurement report of the aerial UE 101A. Accordingly, the measurement report of the aerial UE 101A may be utilized as the measurement report 101M of the aerial UE 101B in the network, and the aerial UE 101B may not transmit the measurement report 101M.

In some implementations, the distance between the aerial UE 101B and the aerial UE 101A may be calculated based on coordinate of latitude and longitude, and height. In detail, the location information 101L may include a coordinate of latitude and longitude, and height of the aerial UE 101A. Accordingly, after receiving the location information 101L, the aerial UE 101B may calculate the distance between the aerial UE 101A and the aerial UE 101B based on current location (i.e., current coordinate of latitude and longitude, and height of the aerial UE 101i) and the coordinate of latitude and longitude, and height of the aerial UE 101A.

In some implementations, the distance between the aerial UE 101B and the aerial UE 101A may be calculated based on three-dimensional zone identification. In detail, the location information 101L may include a three-dimensional zone identification of the aerial UE 101A, and the three-dimensional zone identification of the aerial UE 101A may be determined as following formulas:

x1=└x/L┘ modulo 64

y1=└y/L┘ modulo 64

z1=└z/L┘ modulo 64
the three-dimensional zone identification=z1×64²×y1×64+x1
where L is value of zone length (e.g., sl-ZoneLength included in sl-ZoneConfig defined in the 3GPP specifications),
x is a geodesic distance in longitude between current location of the aerial UE 101A and original geographical coordinate (e.g., geographical coordinate [0, 0]) based on World Geodetic System 84 (WGS84) model,
y is the geodesic distance in latitude between current location of the aerial UE 101A and original geographical coordinate based on WGS84 model, and
z is the geodesic distance in height between current location of the aerial UE 101A and sea level.

Therefore, after receiving the location information 101L, the aerial UE 101B may calculate the distance between the aerial UE 101A and the aerial UE 101B based on current location (i.e., current three-dimensional zone identification of the aerial UE 101B) and the three-dimensional zone identification of the aerial UE 101A.

It should be noted that the location information 101L may be included in a sidelink control information (SCI), a media access control-control element (MAC-CE) or a PC5-RRC signaling, e.g., an 18 bits field in SCI used for three-dimensional zone identification. Moreover, the location information 101L may further include a velocity information of the aerial UE 101A for evaluation of subsequent location of the aerial UE 101A.

In some embodiments, after starting to determine which node to transmit the measurement report 101M to, serving cell condition may be introduced for the aerial UE 101B to determine whether to transmit the measurement 101M to the BS 102 or to the aerial UE 101A. Particularly, serving cell of the aerial UE 101B and serving cell of the aerial UE 101A may be compared for determining whether to transmit the measurement 101M to the BS 102 or to the aerial UE 101A.

In detail, the aerial UE 101B may determine whether the serving cell of the aerial UE 101B is the same as the serving cell of the aerial UE 101A. When the serving cell of the aerial UE 101B is the same as the serving cell of the aerial UE 101A, the aerial UE 101B may transmit the measurement report 101M to the aerial UE 101A or may abandon the measurement report 101M. When the serving cell of the aerial UE 101B is not the same as the serving cell of the aerial UE 101A, the aerial UE 101B may transmit the measurement report 101M to the BS 102.

In some embodiments, after starting to determine which node to transmit the measurement report 101M to, link quality may be introduced for the aerial UE 101B to determine whether to transmit the measurement 101M to the BS 102 or to the aerial UE 101A. Particularly, link quality of Uu link between the aerial UE 101B and the BS 102, and/or link quality of sidelink between the aerial UE 101B and the aerial UE 101A may be evaluated for determining whether to transmit the measurement 101M to the BS 102 or to the aerial UE 101A.

In some implementations, the aerial UE 101B may measure a Reference Symbol Received Power (RSRP) ‘R1’ of the Uu link between the aerial UE 101B and the BS 102. When the RSRP ‘R1’ is less than a threshold ‘TH3’ of the configuration 102C, the aerial UE 101B may transmit the measurement report 101M to the aerial UE 101A or may abandon the measurement report 101M. When the RSRP ‘R1’ is equal to or greater than the threshold ‘TH3’ of the configuration 102C, the aerial UE 101B may transmit the measurement report 101M to the BS 102.

In some implementations, the aerial UE 101B may measure a RSRP ‘R2’ of the sidelink between the aerial UE 101B and the aerial UE 101A. When the RSRP ‘R2’ is less than a threshold ‘TH4’ of the configuration 102C, the aerial UE 101B may transmit the measurement report 101M to the BS 102. When the RSRP ‘R2’ is equal to or greater than the threshold ‘TH4’ of the configuration 102C, the aerial UE 101B may transmit the measurement report 101M to the aerial UE 101A or may abandon the measurement report 101M.

In some implementations, when the RSRP ‘R1’ is less than the RSRP ‘R2’, the aerial UE 101B may transmit the measurement report 101M to the aerial UE 101A or may abandon the measurement report 101M. When the RSRP ‘R2’ is less than the RSRP ‘R1’, the aerial UE 101B may transmit the measurement report 101M to the BS 102.

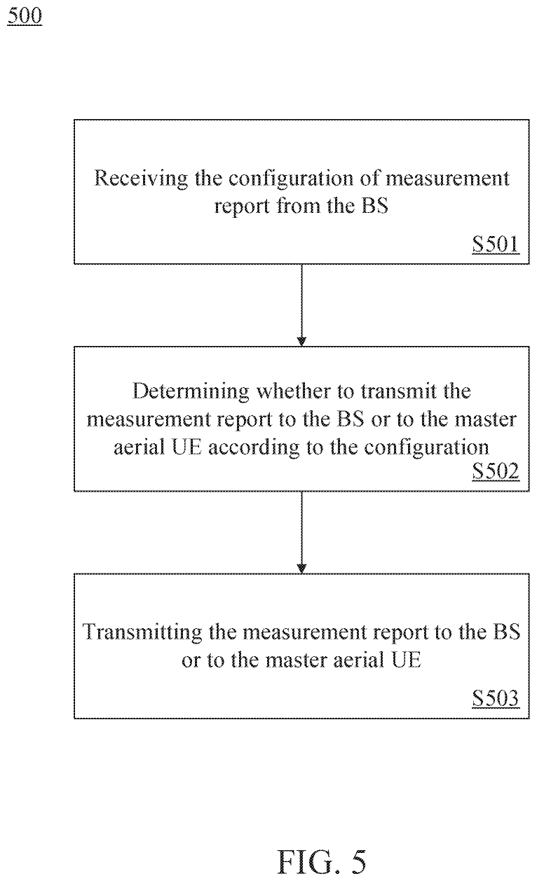

FIG. 5 illustrates a flow chart of a method for wireless communications in accordance with some embodiments of the present application. Referring to FIG. 5, method 500 is performed by a member aerial UE (e.g., the aerial UE 101B) in some embodiments of the present application.

Operation S501 is executed to receive, by the member aerial UE, a configuration of measurement report from a BS (e.g., the BS 102). The configuration of measurement report may be included in an RRC message. Operation S502 is executed to determine, by the member aerial UE, whether to transmit a measurement report to the BS or to a master aerial UE (e.g., the aerial UE 101A) according to the configuration. Operation S503 is executed to transmit, by the member aerial UE, the measurement report to the BS or to the master aerial UE according to a result of operation S502.

More specifically, when it is determined to transmit the measurement report to the BS in operation S502, the member aerial UE transmits the measurement report to the BS in operation S503. When it is determined to transmit the measurement report to the master aerial UE in operation S502, the member aerial UE transmits the measurement report to the master aerial UE in operation S503.

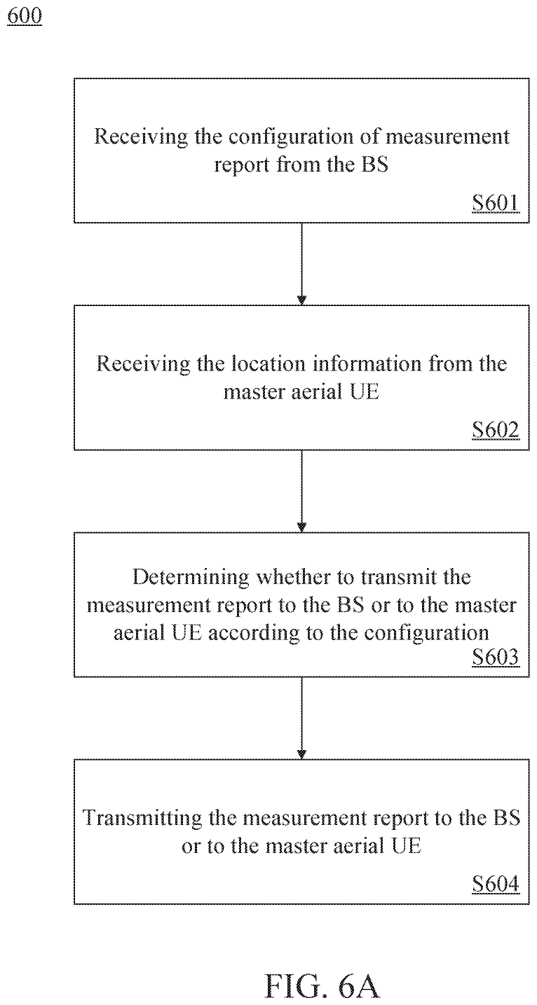

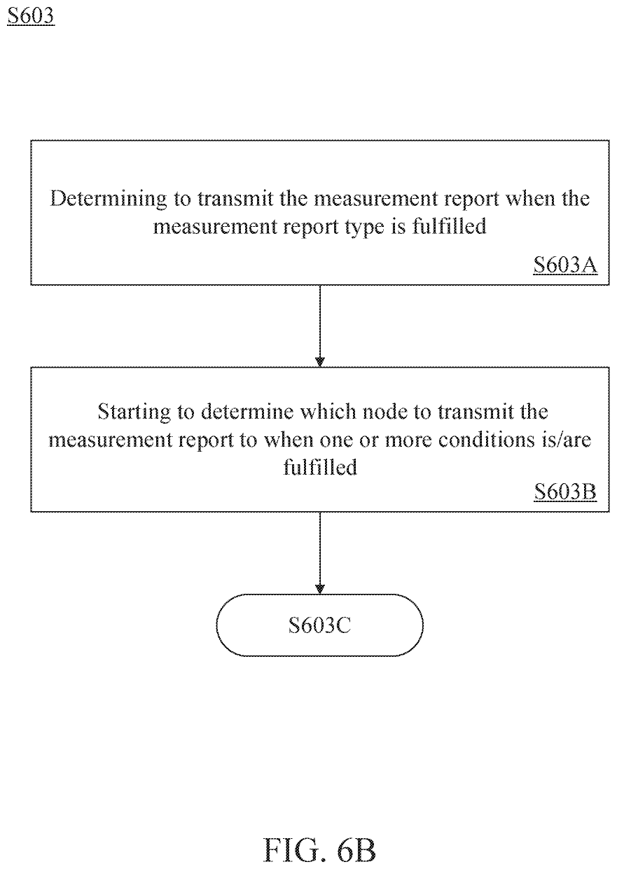

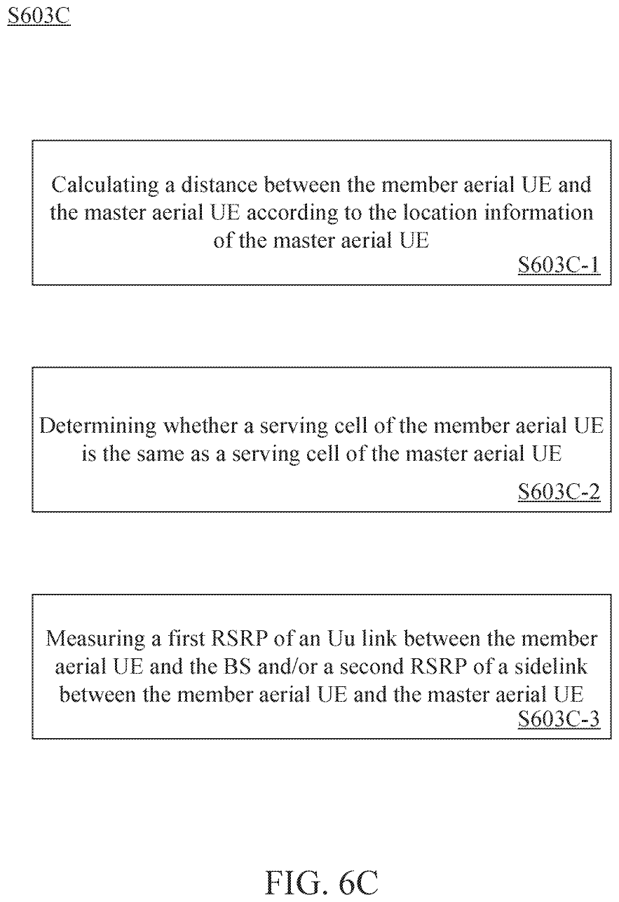

FIGS. 6A to 6C illustrate flow charts of a method for wireless communications in accordance with some embodiments of the present application. Referring to FIGS. 6A to 6C, method 600 is performed by a member aerial UE (e.g., the aerial UE 101B) of an UAV swarm in some embodiments of the present application.

Operation S601 is executed to receive, by the member aerial UE, a configuration of measurement report from the BS (e.g., the BS 102). The configuration of measurement report may be included in an RRC message. Operation S602 is optionally executed to receive, by the member aerial UE, a location information from a master aerial UE (e.g., the aerial UE 101A). In some implementations, the location information may be included in SCI, MAC-CE or PC5-RRC signaling.

Operation S603 is executed to determine, by the member aerial UE, whether to transmit a measurement report to the BS or to a master aerial UE according to the configuration. Operation S604 is executed to transmit, by the member aerial UE, the measurement report to the BS or to the master aerial UE according to a result of operation S603. It should be noted that operation S603 may include sub-operations S603A to S603C as shown in FIG. 6B. Operation S603C may be implemented as one of the sub-operations S603C-1 to S603C-3 as shown in FIG. 6C.

In some embodiments, the configuration may indicate a measurement report type. Operation S603A is executed to determine, by the member aerial UE, to transmit the measurement report when the measurement report type is fulfilled. In some implementations, the measurement report type may be event-based, and the configuration may indicate at least one measurement event. Accordingly, in operation S603A, the member aerial UE may determine to transmit the measurement report when the at least one measurement event is triggered. In some implementations, the measurement report type may be time-based, and the configuration may include a time period. Accordingly, in operation S603A, the member aerial UE may determine to transmit the measurement report every time period.

In some embodiments, the configuration may further include: (1) indicator of enabling/disabling a function of performing transmission of measurement report to master aerial UE; (2) a threshold of distance for performing transmission of measurement report to master aerial UE. Operation S603B to start, by the member aerial UE, to determine which node to transmit the measurement report 101M to when one or more of the following conditions is/are fulfilled:
a) the member aerial UE identifies the master aerial UE according to the configuration;
b) the member aerial UE communicates with the master aerial UE via an unicast connection (e.g., PC5-RRC connection);
c) the member aerial UE is enabled with the function of performing transmission of measurement report to the master aerial UE according to the indicator of the configuration;
d) the member aerial UE is configured with the at least one measurement event (e.g., measurement report trigger events A3/A4/A5 or H1/H2 defined in 3GPP specifications) according to the configuration;
e) the at least one measurement event is triggered;
f) the member aerial UE is configured with the threshold of distance according to the configuration.

Operation S603C-1 is executed to calculate, by the member aerial UE, a distance between the member aerial UE and the master aerial UE according to the location information of the master aerial UE. When the distance is less than a threshold of the configuration, the member aerial UE may transmit the measurement report to the master aerial UE in operation S604. When the distance is equal to or greater than the threshold of the configuration, the member aerial UE may transmit the measurement report to the BS in operation S604.

It should be noted that the distance between the member aerial UE and the master aerial UE may be calculated according to the current location of the member aerial UE and the location information of the master aerial UE.

In some implementations, the location information may include a coordinate of latitude and longitude, and a height of the master aerial UE. Accordingly, after receiving the location information, the member aerial UE may calculate the distance between the member aerial UE and the master aerial UE based on current location (i.e., current coordinate of latitude and longitude, and height of the member aerial UE) and the coordinate of latitude and longitude, and the height of the master aerial UE.

In some implementations, the location information may include a three-dimensional zone identification of the master aerial UE, and the three-dimensional zone identification of the master aerial UE may be determined as following formulas:

x1=└x/L┘ modulo 64

y1=└y/L┘ modulo 64

z1=└z/L┘ modulo 64
the three-dimensional zone identification=z1×64²×y1×64+x1
where L is value of zone length (e.g., sl-ZoneLength included in sl-ZoneConfig defined in the 3GPP specifications),
x is a geodesic distance in longitude between current location of the master aerial UE and original geographical coordinate (e.g., geographical coordinate [0, 0]) based on WGS84 model,
y is the geodesic distance in latitude between current location of the master aerial UE and original geographical coordinate based on WGS84 model, and
z is the geodesic distance in height between current location of the master aerial UE and sea level.

Therefore, after receiving the location information, the member aerial UE may calculate the distance between the member aerial UE and the master aerial UE based on current location (i.e., current three-dimensional zone identification of the member aerial UE) and the three-dimensional zone identification of the master aerial UE.

Operation S603C-2 is executed to determine, by the member aerial UE, whether a serving cell of the member aerial UE is the same as a serving cell of the master aerial UE. When the serving cell of the member aerial UE is the same as the serving cell of the master aerial UE, the member aerial UE may transmit the measurement report to the master aerial UE in operation S604. When the serving cell of the member aerial UE is not the same as the serving cell of the master aerial UE, the member aerial UE may transmit the measurement report to the BS in operation S604.

Operation S603C-3 is executed to measure, by the member aerial UE, a first RSRP of an Uu link between the member aerial UE and the BS and/or a second RSRP of a sidelink between the member aerial UE and the master aerial UE.

In some implementations, when the first RSRP is less than a threshold of the configuration, the member aerial UE may transmit the measurement report to the master aerial UE in operation S604. When the first RSRP is equal to or greater than the threshold of the configuration, the member aerial UE may transmit the measurement report to the BS in operation S604.

In some implementations, when the second RSRP is less than a threshold of the configuration, the member aerial UE may transmit the measurement report to the BS in operation S604. When the second RSRP is equal to or greater than the threshold of the configuration, the member aerial UE may transmit the measurement report to the master aerial UE in operation S604.

In some implementations, when the first RSRP is less than the second RSRP, the member aerial UE may transmit the measurement report to the master aerial UE in operation S604. When the second RSRP is less than the first RSRP, the member aerial UE may transmit the measurement report to the BS in operation S604.

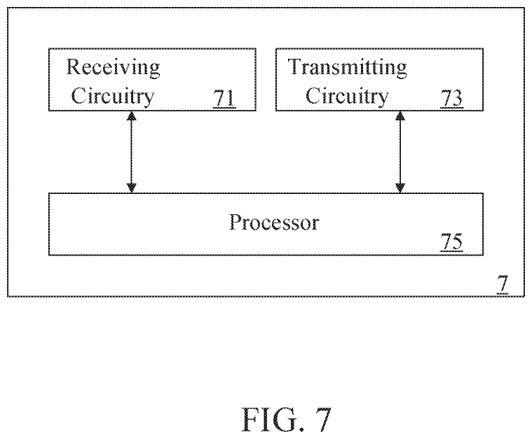

FIG. 7 illustrates an example block diagram of an apparatus 7 according to an embodiment of the present disclosure.

As shown in FIG. 7, the apparatus 7 may include at least one non-transitory computer-readable medium (not illustrated in FIG. 7), a receiving circuitry 71, a transmitting circuitry 73, and a processor 75 coupled to the non-transitory computer-readable medium (not illustrated in FIG. 7), the receiving circuitry 71 and the transmitting circuitry 73. The apparatus 7 may be an aerial UE, a computing device of a flying machine or a BS.

Although in this figure, elements such as processor 75, transmitting circuitry 73, and receiving circuitry 71 are described in the singular, the plural is contemplated unless limitation to the singular is explicitly stated. In some embodiments of the present disclosure, the receiving circuitry 71 and the transmitting circuitry 73 are combined into a single device, such as a transceiver. In certain embodiments of the present disclosure, the apparatus 7 may further include an input device, a memory, and/or other components.

In some embodiments of the present disclosure, the non-transitory computer-readable medium may have stored thereon computer-executable instructions to cause a processor to implement the method with respect to the aerial UE as described above. For example, the computer-executable instructions, when executed, cause the processor 75 interacting with receiving circuitry 71 and transmitting circuitry 73, so as to perform the operations with respect to the aerial UE depicted in FIGS. 1 to 4.

In some embodiments of the present disclosure, the non-transitory computer-readable medium may have stored thereon computer-executable instructions to cause a processor to implement the method with respect to the BS as described above. For example, the computer-executable instructions, when executed, cause the processor 75 interacting with receiving circuitry 71 and transmitting circuitry 73, so as to perform the operations with respect to the BS depicted in FIGS. 1 to 4.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

1. A method of a first aerial user equipment (UE), comprising:
receiving a configuration of measurement from a base station (BS);
determining whether to transmit a measurement report to the BS or to a second aerial UE according to the configuration; and
transmitting the measurement report to the BS or to the second aerial UE according to a result of determining whether to transmit the measurement report to the BS or to the second aerial UE.

2. The method of claim 1, wherein the configuration indicates a measurement report type, and the method further comprises:
determining to transmit the measurement report when a condition of the measurement report type is fulfilled.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. An apparatus, comprising:
a receiving circuitry;
a transmitting circuitry; and
a processor coupled to the receiving circuitry and the transmitting
circuitry, wherein the apparatus comprises a first aerial user equipment (UE) and the processor is configured to cause the apparatus to:
receive a configuration of measurement from a base station (BS);
determine whether to transmit a measurement report to the BS or to a second aerial UE according to the configuration; and
transmit the measurement report to the BS or to the second aerial UE according to a result of determining whether to transmit the measurement report to the BS or to the aerial UE.

24. The apparatus of claim 23, wherein the configuration indicates a measurement report type, and the processor is further configured to cause the apparatus to:
determine to transmit the measurement report when a condition of the measurement report type is fulfilled.

25. The apparatus of claim 24, wherein the measurement report type is event-based, the configuration indicates at least one measurement event, and to determine to transmit the measurement report is to:
determine to transmit the measurement report when the at least one measurement event is triggered.

26. The apparatus of claim 24, wherein the measurement report type is time-based, the configuration includes a time period, and to determine to transmit the measurement report is to:
determine to transmit the measurement report every time period.

27. The apparatus of claim 24, wherein the processor is further configured to cause the apparatus to:
identify the second aerial UE according to the configuration.

28. The apparatus of claim 23, wherein the processor is further configured to cause the apparatus to:
receive location information from the second aerial UE.

29. The apparatus of claim 28, wherein the location information is included in a sidelink control information, a media access control-control element or a PC5-RRC signaling.

30. The apparatus of claim 28, wherein to transmit the measurement report to the BS or the second aerial UE is to:
calculate a distance between the apparatus and the second aerial UE according to the location information of the second aerial UE; and
transmit the measurement report to the second aerial UE when the distance is less than a threshold of the configuration of measurement.

31. The apparatus of claim 28, wherein to transmit the measurement report to the BS or the second aerial UE is to:
calculate a distance between the apparatus and the second aerial UE according to the location information of the second aerial UE; and
transmit the measurement report to the BS when the distance is equal to or greater than a threshold of the configuration of measurement.

32. The apparatus of claim 23, wherein to transmit the measurement report to the BS or the second aerial UE is to:
determine whether a serving cell of the apparatus is a same serving cell as a serving cell of the second aerial UE;
transmit the measurement report to the second aerial UE when the serving cell of the apparatus is the same as the serving cell of the second aerial UE.

33. The apparatus of claim 23, wherein to transmit the measurement report to the BS or the second aerial UE is to:
determine whether a serving cell of the apparatus is a same service cell as a serving cell of the second aerial UE;
transmit the measurement report to the BS when the serving cell of the apparatus is not the same as the serving cell of the second aerial UE.

34. The apparatus of claim 23, wherein to transmit the measurement report to the BS or the second aerial UE is to:
measure a Reference Symbol Received Power (RSRP) of a link between the apparatus and the BS; and
transmit the measurement report to the second aerial UE when the RSRP is less than a threshold of the configuration of measurement.

35. The apparatus of claim 23, wherein to transmit the measurement report to the BS or the second aerial UE is to:
measure a Reference Symbol Received Power (RSRP) of a link between the apparatus and the BS; and
transmit the measurement report to the BS when the RSRP is equal to or greater than a threshold of the configuration of measurement.

36. The apparatus of claim 23, wherein to transmit the measurement report to the BS or the another aerial UE is to:
measure a Reference Symbol Received Power (RSRP) of a link between the apparatus and the second aerial UE; and
transmit the measurement report to the second aerial UE when the RSRP is equal to or greater than a threshold of the configuration of measurement.

37. The apparatus of claim 23, wherein to transmit the measurement report to the BS or the second aerial UE is to:
measure a Reference Symbol Received Power (RSRP) of a link between the apparatus and the second aerial UE; and
transmit the measurement report to the BS when the RSRP is less than a threshold of the configuration of measurement.

38. The apparatus of claim 23, wherein to transmit the measurement report to the BS or the second aerial UE is to:
measure a first Reference Symbol Received Power (RSRP) of a link between the apparatus and the BS;
measure a second RSRP of a link between the apparatus and the second aerial UE; and
transmit the measurement report to the second aerial UE when the first RSRP is less than the second RSRP.

39. The apparatus of claim 23, wherein to transmit the measurement report to the BS or the second aerial UE is to:
measure a first Reference Symbol Received Power (RSRP) of a link between the apparatus and the BS;
measure a second RSRP of a link between the apparatus and the second aerial UE; and
transmit the measurement report to the BS when the second RSRP is less than the first RSRP.

40. The apparatus of claim 23, wherein the apparatus and the second aerial UE are in a same unmanned aerial vehicle swarm.
